(19) United States
(12) Patent Application Publication
(10) Pub. No.: US 2018/0159828 A1
(43) Pub. Date: Jun. 7, 2018

(54) MULTI-REGIONAL PROVISIONING

(71) Applicant: Ingenu, San Diego, CA (US)

(72) Inventors: Matthew Hughes, San Diego, CA (US); Theodore Myers, San Diego, CA (US); Daniel Werner, San Diego, CA (US); Alain Charles, San Diego, CA (US); Avinash Jain, San Diego, CA (US)

(21) Appl. No.: 15/369,936

(22) Filed: Dec. 6, 2016

(51) Int. Cl. H04L 29/06; H04L 9/08

(52) U.S. Cl. CPC H04L 63/0428; H04L 9/0819; H04L 63/10

(57) ABSTRACT

Methods, systems, and apparatuses, including computer programs encoded on computer-readable media, configured to receive, at a module from a provisioning server, a node identification and an access code. The module joins a network that the module has not previously joined. The module provides the node identification to the network. The network uses the node identification and access code to verify that the module is valid. The module receives from the network a new encryption key to use when sending data on the network. The module encrypts data using the new encryption key. The encrypted data is transmitted on the network.

### BACKGROUND

Data networks typically have regional coverage. Data network modules are normally configured for a particular region. Modules can roam between data networks and between regions. Agreements between the data networks allow for such roaming. The region in which a module will operate is normally known when the module is manufactured or shipped. This knowledge allows modules to comply with regional regulations and for the modules to register with data networks.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a diagram illustrating multi-regional provisioning of modules in accordance with one implementation.

FIG. 2 is a diagram illustrating multi-regional provisioning of modules in accordance with one implementation.

FIG. 3 is a timing diagram showing multi-regional provisioning in accordance with one implementation.

FIG. 4 is a diagram showing multi-regional roaming in accordance with one implementation.

FIG. 5 is a timing diagram showing multi-regional roaming in accordance with one implementation.

FIG. 6 is a diagram showing configuration of networks that provide multi-regional roaming in accordance with one implementation.

FIG. 7 is a diagram showing configuration of networks that use a common platform to provide multi-regional roaming in accordance with one implementation.

FIG. 8 is a diagram showing configuration of networks that provide multi-regional roaming in accordance with one implementation.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

A global data network allows a module to access the data network across many regions. Rather than a single network operator, a global data network can be achieved using a number of different network operators. These network operators can be spread across a region, a country, and/or across the globe. Such a data network allows a module to access the data network in any region covered by the data network, regardless of the network operator of any particular data network. There are a number of technical challenges to allow this access.

Currently, modules that access a data network are configured for a particular region. Certain regions have various regulatory constraints. When modules are manufactured or shipped, the module can be configured to comply with any regulatory constraints. For example, the maximum transmit power of a module is a common regulatory constraint. Modules can be configured never to transmit with a power greater than the regulatory constraint. A module for a global data network, however, may first access the data network from one of many different regions. These regions may have separate and distinct constraints compared to other regions. The modules, therefore, need a way to comply with various different regulatory constraints without relying on those constraints being configured when the module is shipped.

Modules also need a way to register with the data network regardless of the network operator used to access the data network. A common registration database can be used to verify a module and provision the module for a particular data network operator. The data network operator can then provision the module for secure communication on the global data network via the data network operator. The common registration database allows modules to be initially provisioned without having to know the network operator that will be used to access the data network. Thus, configuring of the module, managing inventory, and shipping of the modules can be simplified.

Using the common registration database allows the module to be provisioned using any network operator. Security, therefore, can be an issue if data to/from the module is secured the same way across all data network operators. As the global network is comprised of many different network operators, in various implementations the communications between a module and a specific data network are secured from other data network operators. This data isolation ensures that one network operator is unable to determine the data being sent on a different data network. To be multi-regional, a module can roam between different data networks. Security of the module's communications can be achieved with a process similar to provisioning the module.

Various different types of networks can be used in the multi-regional network. For example, in at least one implementation, the modules and network use random phase multiple access (RPMA) to communicate.

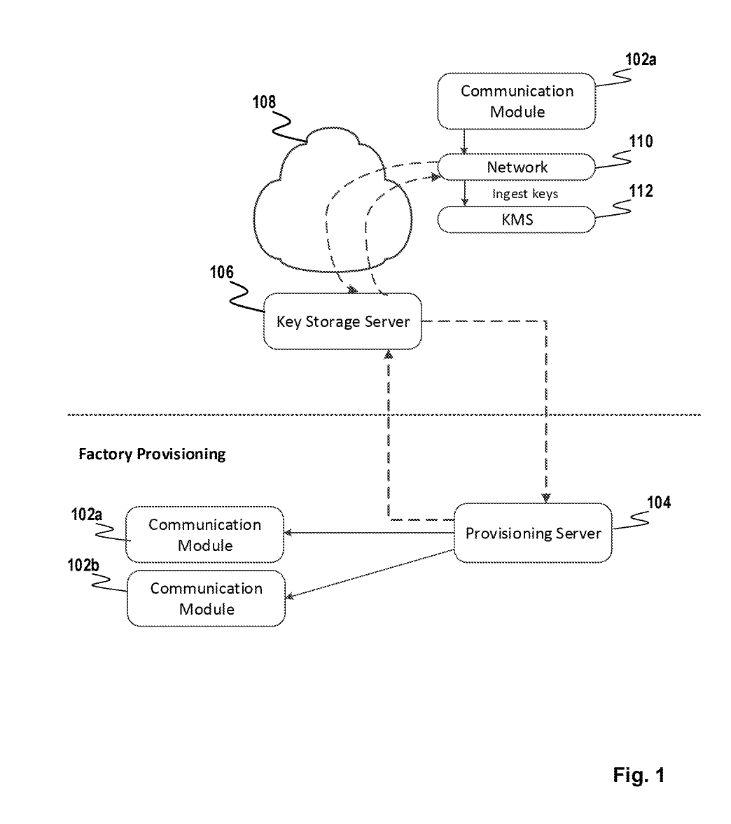

FIG. 1 is a diagram illustrating multi-regional provisioning of modules in accordance with one implementation. Communication modules 102a and 102b are manufactured with the purpose of communicating with any of a number of networks, such as network 110. The eventual network or networks used by the modules 102a and 102b do not have to be known at the time of manufacture or shipment. The network 110 can be part of a larger multi-regional network that includes two or more networks. The communication modules 102a and 102b can be a module that is designed to be built into other devices. The communication modules 102a and 102b are designed to provide wireless communication with various networks such as network 110.

During factory provisioning, the communication modules 102a and 102b are built. Building the communication modules 102a and 102b includes loading and configuring software into each module. Generally, the network and/or region that the communication module will function in is known at build time. The module, therefore, can be configured for a network or region during factory provisioning. In the various implementations discussed herein, the regions and network that the communication modules 102a and 102b will function in is not known. Accordingly, the communication modules 102a and 102b cannot be configured for a particular network or a particular region.

Even without the network and region configuration, the communication modules 102a and 102b are able to operate properly on any of the networks that make up a global network. To achieve this operability, a provisioning server 104 can be used during the building of the communication modules 102a and 102b. The provisioning server 104 provides a node ID to both a communication module 102a and also to a key storage server 106. The node ID identifies a particular communication module 102a from other communication modules. In addition, the provisioning server 104 maps the node ID to an access code. The access code is also provided to the key storage server 106 that also connects the node ID with the access code.

In various implementations, each communication module 102a stores its node ID in memory within the communication module. In these implementations, the access code is provided along with the communication module but is not stored within any memory within the communication module. In other implementations, both the node ID and the access code are stored within one or more memories of the communication module. In addition, a global network key can also be stored in the communication module. This global network key can be provided by the provisioning server 104.

The global network key can be used by the communication module when accessing a network where the communication module is not yet provisioned/configured for a specific network. When a communication module is not configured on a network, the communication module can send a request to the network to join the network. This request can be encrypted using the global network key. The receiving network can either know the global network key or request the global network key from the key storage server 106. This capability allows the network and the communication module to communicate securely before the communication module is configured on the network.

As part of the join request, the communication module can provide both its node ID and access code to the network 110. In other implementation, the communication module can provide its node ID, with the network 110 previously being provided the node ID and access code mapping. The network 110 can send the node ID and access code to the key storage server 106 for validation. The key storage server 106 can verify that the provided access code matches the provided node ID. This information is not directly available to the network 110, which provides a barrier of security by not allowing networks to know valid node ID and access code pairs until that information is provided to the network. The key storage server 106 provides an indication as to whether the node ID and access code pair is valid. If the pair is valid, the network 110 can reprovision the communication module 102a specifically for that network 110.

Communication modules and networks could continue to use the known global key, but at the cost of security. Anyone with the global key would be able to receive and decrypt communications between communication modules 102a and 102b and any network. To create secure communications, each communication module will use a key unique to a particular network after the communication module is provisioned on that network. After the network 110 verifies the node ID and access code pair, the network can create its own set of keys that the communication module 102a will use to secure communications with the network 110. The keys for the network 110 can be stored in a key management system 112 that is controlled by the network 110. This ensures that other networks would not have access to the keys of the network 110 without the approval of the network 110.

In other implementations, each network can use a separate key that is derived from the global key. For example, a network can broadcast a network identifier that uniquely identifies the network. This network identifier can be used in combination with the global key to derive a new key specific for that network. This requires that both the communication module and the network understand how the key was derived.

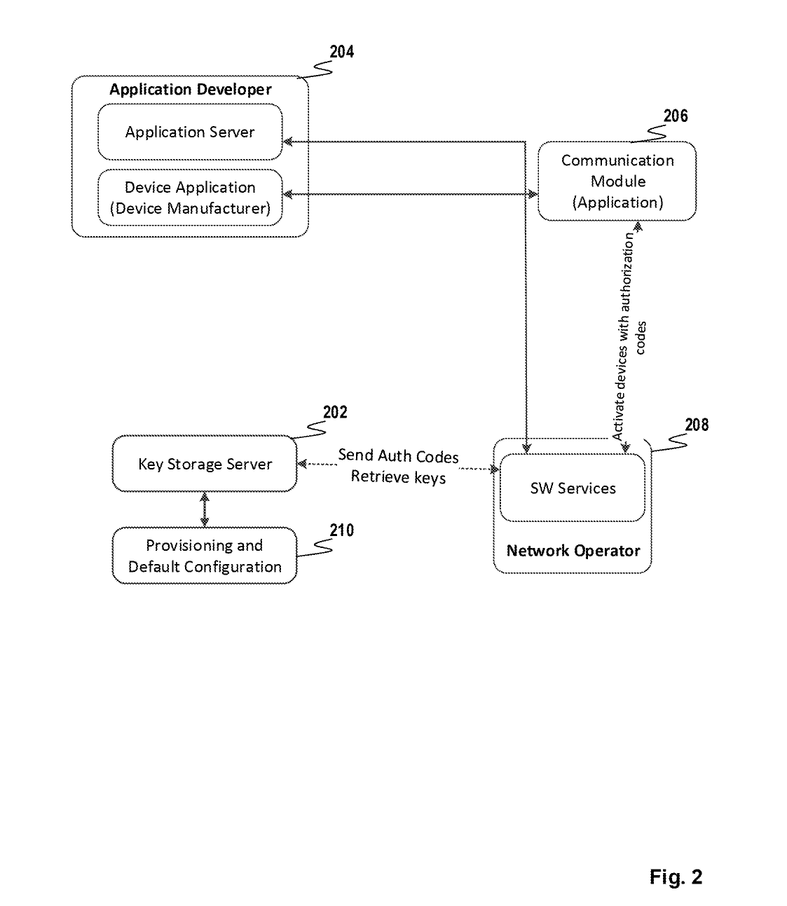

FIG. 2 is a diagram illustrating multi-regional provisioning of modules in accordance with one implementation. FIG. 2 is similar to FIG. 1, where a key storage server 202 stores node IDs and access codes. The node IDs and access codes can be created during the manufacture of the modules and provided to the key storage server 202 by a provisioning and default configuration server 210. The modules can then be sent to various networks, outlets, or application developers 204. For example, the application developer 204 can create various products that incorporate modules that communicate on the multi-regional network. Application examples include utility usage monitoring, pipe monitoring, text communications, voice communications, etc. The application developer incorporates modules 206 and then sends to deployments, customers, etc. The modules 206 can communicate with any network of the multi-regional network and do not require initially accessing any particular network.

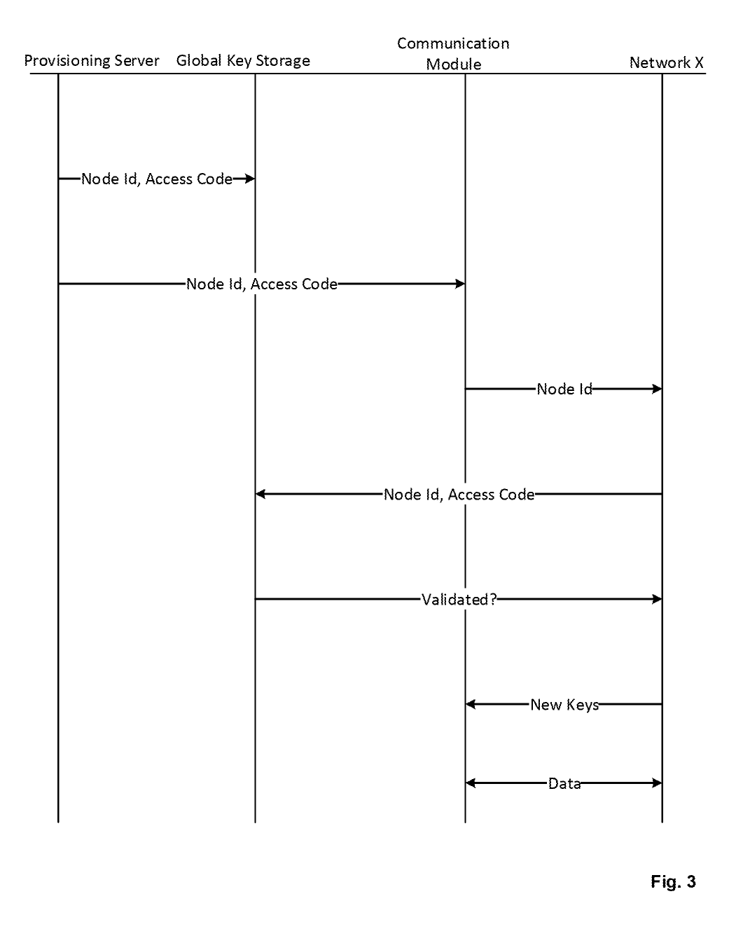

As described in relation to FIGS. 1 and 3, the module can access a network that provides various services. For example, data services can be provided by a network 208. The network 208 can allow modules to communicate with application servers of the application developer 204. When first accessing a network, the module can provide both its node ID and an access code. The network 208 can verify that the node ID and access code are both valid and linked via the key storage server 202. The key storage server 202 is available to any network that is part of the multi-regional network. In some implementations, there can be more than one key storage server that has common access code and node ID data shared between the key storage servers. In other implementations, the key storage servers can communicate with one another to handle authorization. For example, a first subset of key servers can contain a first set of node IDs and access codes. Another different subset of key servers can contain a second set of node IDs and access codes. Any key server can verify any node ID and access code by communication with a different key server as needed. In one implementation, if a node ID is not found in a particular key server, the key server can request that another key server verify the provided node ID and access code.

In other implementations, the network 208 can receive valid pairs of access codes and node IDs. For example, the application developer 204 can provide valid pairs of access codes and node IDs to the network operator 208. The network operator 208 can then verify the data using the key storage server 202 or wait until a mobile joins. Then, the module 206 can provide the node ID, the access code, or both to the network operator. The network operator can then verify that the module is valid.

FIG. 3 is a timing diagram showing multi-regional provisioning in accordance with one implementation. A provisioning server provides both a node ID and an access code to a global key storage. The global key storage can be a key storage that is accessible by any valid network that is part of the multi-regional network. In some implementations, the provisioning server can provide the node ID and access code to various networks, such as Network X. This capability allows any valid network access to the key storage such that a communication module can be authenticated. The provisioning server also provides the node ID to a module. The module can store the node ID in persistent memory. In various implementations, the access code can be provided to the module that can store the access code in persistent memory. Once the module and the global key storage have the data from the provisioning server, the module can be shipped and used in any area/region covered by the multi-regional network.

When the module is first put into use, the module scans for a network to access. Once a network has been found, the module determines that the module has not previously joined the found network. Using either a global key or a key derived from a global key and some network provided information, the module requests to join the network. In one implementation, the module provides its node ID to the network. The network, having already received the access code mapped to the node ID from the provisioning server or another server, validates that the provided node ID is both known and valid. In another implementation, the module provides both its node ID and its access code. The network validates that the provided node ID is a valid node ID and access code pair by providing both to the global key storage. In other implementations, the global key storage is not globally accessible. Rather, the node ID and access code pair are provided to a server that can access the global key storage. The server or the global key storage verifies that the data is valid and provides an indication of validation back to the network. If the module is not validated, the network can prohibit the module from accessing the network.

When the module is validated, the network can provide new keys to the module. This functionality allows each network to use keys that are different than the keys used on other networks. This capability ensures that communication on one network can be secured from other networks. In one implementation, the network can generate a set of keys without using the node ID, access code, or previously used key. In other implementations, the network can use the information associated with a module to generate a key specific to the module and the network. The new keys are provided to the module. The module and the network can then use the new keys to secure data communication between them.

In various implementations, a multi-regional network includes multiple independent network operators that work together to provide seamless data capabilities to modules. As described above, each network can secure data with a module using a set of keys specific to that network and/or network and module. Accordingly, when a module accesses a network, the module and network must use the same set of keys to communicate securely.

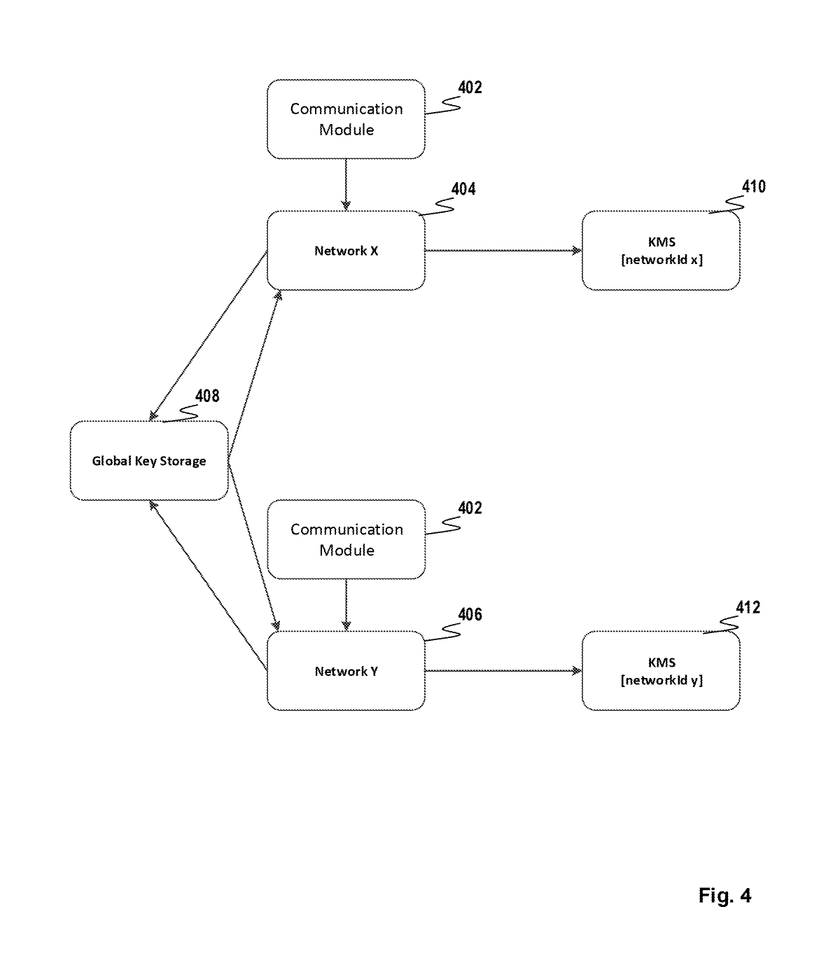

FIG. 4 is a diagram showing multi-regional roaming in accordance with one implementation. A module 402 can access a first network, network X 404. The network X can use the global key or a key derived from the global key to establish a secure connection to the module. As described above, network X 404 can use a global key storage 408 to verify that the module 402 is allowed to access the multi-regional network. The network X 404 can then provide a key specific for the module 402 to both the module 402 and the network's own key management server 410. The module 402 can then use the reprovisioned keys to send/receive secure data from the network 404.

The module 402 can later attempt to access a second network, network Y 406. For example, the module 402 can move geographic locations such that network Y 406 provides service coverage compared to network X 404. The module 402 recognizes that the module 402 is not provisioned on network Y. For example, the module 402 can use the network identifier of network Y 406 to determine that the module does not have a key to use with network Y. The module 402 can then request to join network Y 406 by providing the module's node ID and access code. Network Y can then verify the node ID and access using the global key storage 408 in a similar way as described above. Once verified, a new key, specific to network Y, is created and stored both in the module 402 and network Y's key management server 412. The module 402 can store keys to one or more different networks. When accessing a network for the first time, the module 402 can determine if a key for that network is stored on the module 402 and use that key. If there is no key, the module 402 can request to join the network as described above.

In various implementations, network X 404 and network Y 406 can communicate with one another. For example, once the module 402 registers on network X 404, network X 404 can provide the node ID and provisioned key to network Y 406. Then when module 402 access network Y 406 using the provisioned key, network Y 406 can verify the module 402 is a valid module 402 without having to access the global key storage 408. In other implementations, network Y 406 can verify the module using the global key storage 408, as described above. Network X 404 can include a list of other networks to provide the module's information. When a module access the network X 404 for the first time, network X 404 can provide the relevant information to each of the networks in the list of networks.

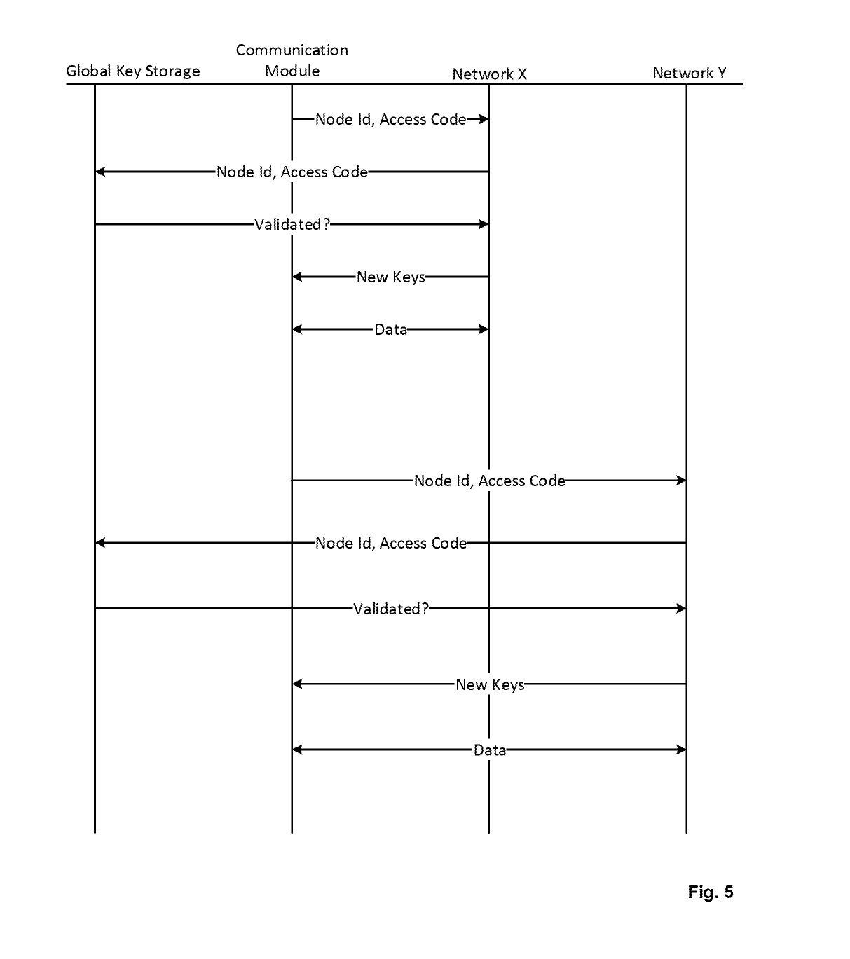

FIG. 5 is a timing diagram showing multi-regional roaming in accordance with one implementation. The module provides its node ID and access code to a network, network X. Network X validates the node Id and access code by providing this data to the global key storage. In one implementation, the node ID and access code are not directly provided. Instead, data, such as a hash value derived from the node ID or access code, is provided to the global key storage. The global key storage can then verify that the derived data is accurate by recreating the derived data. For example, the node ID and a hash of the access code can be provided. Once validated, new keys are created and sent to the module. Network X also stores these keys for use with communication with the module. Later, the module can access network Y and determine that the module needs to join network Y. For example, when the module does not have a key for network Y, the module requests to join the network Y. Similar to accessing network X, the module provides its node ID and access code. Network Y verifies the node ID and access code by contacting the global key storage in a way similar to how network X validated the module. Once validated, network Y creates and stores keys for the module and sends the keys to the module. The module then uses these keys to communicate with network Y. Later, when the module attempts to access network X, the module determines that a key for network X has already been stored within the module's memory. Rather than revalidating the network X, the module uses the stored key for network X to communicate with network X. Thus, a module will store keys for each network that the module has successfully joined.

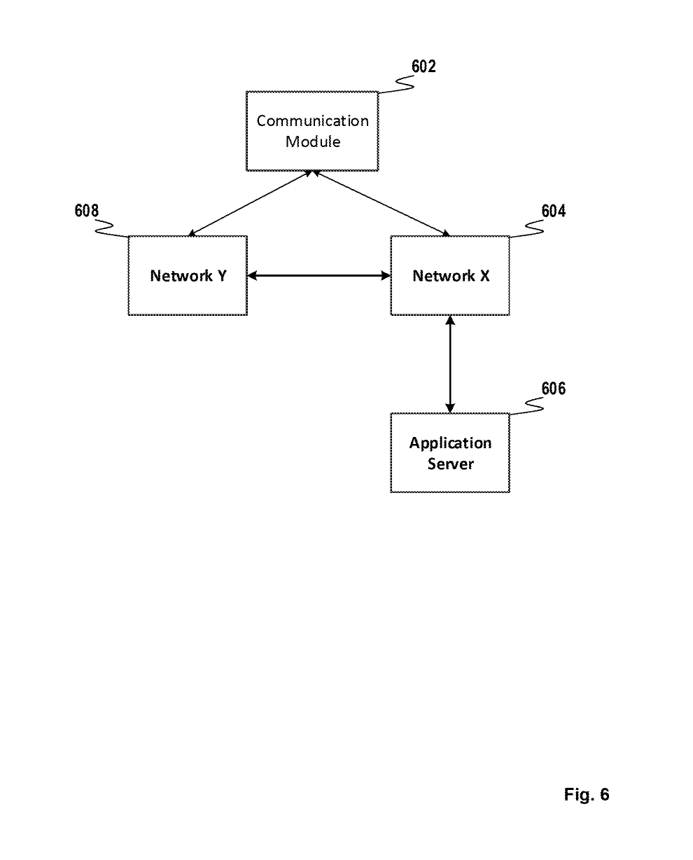

While a multi-regional network allows a module to roam between networks, some communication or management between networks is needed for purposes such as billing. FIG. 6 is a diagram showing configuration of networks that provide multi-regional roaming in accordance with one implementation. A module 602 is able to access both network X 604 and network Y 608. Network X 604 is the module's home network. The home network includes a gateway and a key management server for network X 604. When the module 602 roams to network Y 608, network Y's gateway and key management server can be used. For example, the key management server of network Y 608 is used to determine what key or keys to use to secure communication between network Y 608 and the module 602.

Network X 604 and network Y 608 communicate with one another to determine what services the module 602 can access and also how much data/time the module 602 used on network Y. This allows network X to bill a module properly and enforce service agreements. In addition, the communication module 602 is able to reach an application server 606 regardless of the network. This ensures that the communication module 602 is able to access one or more applications as the communication module roams across different networks. The application server 606 provides one or more specific services for the communication module. For example, the application 606 can track the location of the module 602. The module 602 can send its location to the application server 606 that can store the module's location.

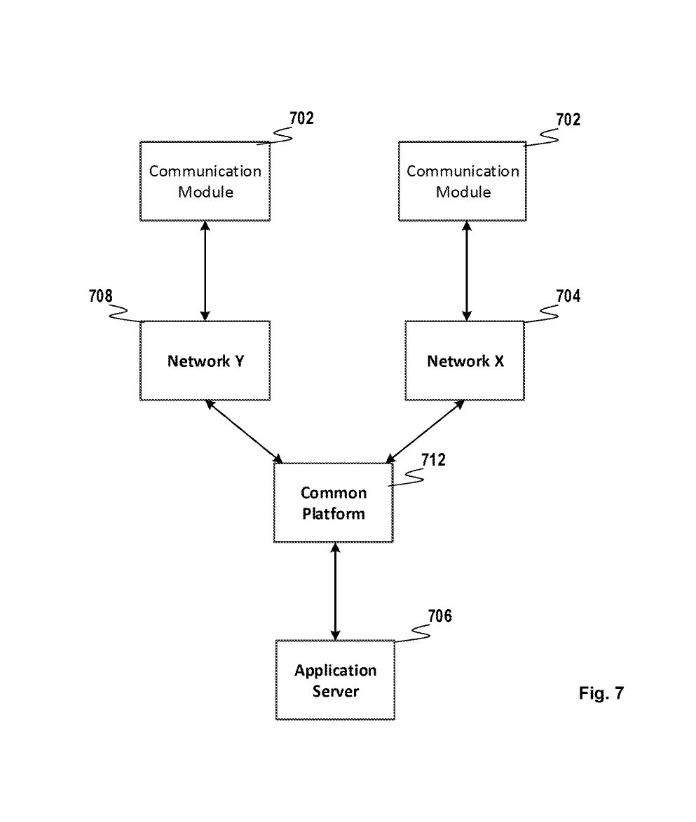

In another example, a common platform can manage a module's use of different networks. Rather than having networks communication with one another, the networks can communication with a common platform to access applications. FIG. 7 is a diagram showing configuration of networks that use a common platform to provide multi-regional roaming in accordance with one implementation. FIG. 7 includes a common platform 712 that the module 702 uses to access an application server 706. Accordingly, all data communication between the module and the application server 706 is done through the common platform 712. The common platform 712, therefore, can enforce service agreements and monitor the module's network usage.

The communication module 702 can access both network X 704 and then at a later time roam onto network Y 708. Both network X 704 and network Y 708 communicate with the common platform 712 to provide the communication module 702 with access to the application server 706. As described above, the communication module 702 can request to join each network and be provided with keys to secure communication between the module and the network. The common platform can use keys to secure communication between the common platform and any network. For example, the common platform can provide one or more of the networks with a key to use or provide a specific key to each network. In one implementations, the common platform 712 can request that a network provide a specific key to be used to secure traffic between the network and the common platform.

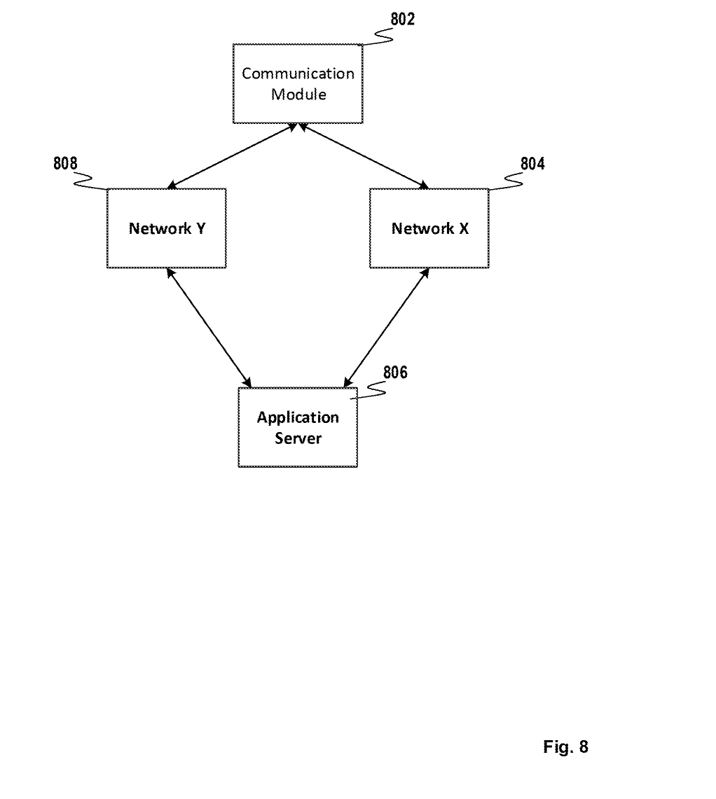

FIG. 8 is a diagram showing configuration of networks that provide multi-regional roaming in accordance with one implementation. FIG. 8 is similar to FIG. 6, but both network X 804 and network Y 808 can access application server 806. In this example, network X 804 and network Y do not have to communicate with one another to provide communication module 802 access to the application server 806.

As modules may operate in numerous different networks, each module must be able to conform to various requirements of each network. For example, the maximum transmit power of module can vary across different networks. Maximum transmit power must be determined to prevent the module from transmitting on a network with a power greater than the maximum transmit power across all networks. Accordingly, the module is able to transmit at the region's maximum transmit power without exceeding the maximum transmit power. This also avoids the module having to determine all possible transmit powers and selecting the minimum of these values to ensure the transmit power is less than the maximum transmit power over all of the regions.

Prior to transmitting on a network, a module will receive certain information, such as the network identifier, from the network. In various implementations, the network identifier can be specified via a broadcast channel. When a module first accesses a network, the module can listen on the broadcast channel for a broadcast message. As described above, the network identifier can be used to determine which keys the module uses to secure data transmissions. In addition to the network identifier, the broadcast channel can include one or more messages that provide regulatory information.

In one implementation, the regulatory information provides both a constraint type and a constraint limit value. The constraint type indicates a specific type of maximum transmission constraint. The constraint limit value provides one or more values that are network configurable and are used to calculate the maximum transmission value. In addition to the regulatory information, the module can include data that is also used in calculating the maximum transmission power. For example, one or both of antenna gain and cable loss can be used to calculate the module's maximum transmission power. These values can be provided to the module during manufacturing or changed by one or more networks, such as the module's home network.

In one implementation, there can be up to six different constraint types. Each constraint type has a different formula to calculate the module's maximum transmission power. As modules can operate on networks that can require any of these constraint types, each module is able to calculate the maximum transmission value for each of the available constraint types. In addition, there are various places/ways that the module's transmit power can be calculated. For example, the equivalent isotropically radiated power (EIRP) can be used. EIRP can be thought of as the output power+cable loss between the power amplifier and the antenna plus the antenna gain. Another example is conductive power which is a measurement of how much power was received by the antenna. The conductive power can be considered the output power plus the cable loss of the cable between the power amplifier and the antenna. Output power is another example that is the power that the power amplifier is providing. In some devices, the power amplifier can radiate out of band with overdriven. Thus, limiting output power can be used to ensure that a module's power amplifier is not overdrive and/or not transmitting out of band.

One constraint type calculates the maximum transmission value as the constraint limit minus the module's antenna gain plus the module's cable loss. Other maximum transmission values can be calculated using one of the following output power limit; conducted power; and/or equivalent isotropically radiated power (EIRP).

In the above examples, the output power limit, conducted power, and constraint limit value can be provided as part of the constraint limit values. In another example, the maximum transmission power is based upon the received power at the module's antenna. In this example, the maximum transmission power is calculated as either a first maximum transmission power as a first constraint limit value−the antenna gain+cable loss or a second maximum transmission power of second constrains limit value−the antenna gain+cable loss. The maximum transmission power is determined based upon the received power. If the received power is greater than the first constraint limit value−the antenna gain+cable loss, then the first transmission power used. Otherwise, the second transmission power is used.

Regardless of how the maximum transmission value is calculated, modules can limit the maximum transmission power based upon a configuration parameter of the module. After calculating the maximum transmission power, the calculated value can be compared with a stored maximum value. The maximum transmission power can then be set to be the minimum of these two values or set to a third value that is less than the store maximum transmission power value.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
receiving, at a module and from a provisioning server, a node identification, wherein the provisioning server has no communication with a regional network;
providing, from the module, a request to join the regional network, wherein the request encrypted with an initial key created by the regional network;
joining, by the module and after receiving the node identification from the provisioning server, the regional network, wherein the regional network has no communication with the provisioning server, wherein the module has not joined the regional network prior to the joining;
providing, from the module, the node identification to the regional network, wherein the regional network uses the node identification and an access code to verify that the module is valid;
receiving, at the module and from the regional network, a new encryption key created by the regional network to use when sending data on the regional network;
encrypting, at the module, data using the new encryption key; and
transmitting, from the module, the encrypted data on the regional network.

2. The method of claim 1, further comprising:
receiving, at the module, a network identification from the regional network prior to joining the regional network; and
determining, at the module, the module does not have the new encryption key associated with the network identification.

3. The method of claim 2, wherein the initial key is a global network key.

4. The method of claim 2, further comprising deriving the initial key based upon the network identification.

5. The method of claim 1, wherein the regional network receives the node identification and the access code prior to the module joining the regional network.

6. The method of claim 1, further comprising providing, from the module, the access code along with the node identification.

7. The method of claim 2, further comprising storing the new encryption key mapped to the network identification.

8. The method of claim 1, wherein the new encryption key is based upon the node identification.

9. The method of claim 1, wherein the new encryption key is based upon the access code.

10. The method of claim 1, further comprising:
joining, by the module, a second regional network, wherein the module has not joined the second regional network prior to the joining;
providing, from the module, the node identification to the second regional network, wherein the second regional network uses the node identification and access code to verify that the module is valid, and wherein the node identification is encrypted with a second initial key;
receiving, from the second regional network, a second new encryption key to use when sending data on the second regional network, wherein the second new encryption key is different from the new encryption key;
encrypting, at the module, second data using the second new encryption key; and
transmitting the second encrypted data on the second regional network.

11. A communication device configured to:
receive, from a provisioning server, a node identification, wherein the provisioning server has no communication with a regional network;
provide a request to join the regional network, wherein the request encrypted with an initial key created by the regional network;
join, after receiving the node identification and the access code from the provisioning server, the regional network, wherein the regional network has no communication with the provisioning server, wherein the module has not previously joined the regional network;
provide the node identification to the regional network, wherein the regional network uses the node identification and an access code to verify that the module is valid;
receive, from the regional network, a new encryption key created by the regional network to use when sending data on the regional network;
encrypt data using the new encryption key; and
transmit the encrypted data on the regional network.

12. The communication device of claim 11, wherein the module is further configured to:
receive a network identification from the regional network prior to joining the regional network; and
determine the module does not have the new encryption key associated with the network identification.

13. The communication device of claim 12, wherein the initial key is a global network key.

14. The communication device of claim 12, wherein the module is further configured to derive the initial key based upon the network identification.

15. The communication device of claim 11, wherein the regional network receives the node identification and access code prior to the module joining the regional network.

16. The communication device of claim 11, wherein the module is further configured to provide the access code along with the node identification to the regional network.

17. The communication device of claim 12, wherein the module is further configured to store the new encryption key mapped to the network identification.

18. A non-transitory computer-readable storage medium comprising instructions, the instructions for controlling a computer system to perform operations comprising:
receiving, at a module and from a provisioning server via a communication link, a node identification, wherein the provisioning server has no communication with a regional network;
providing, from the module, a request to join the regional network, wherein the request encrypted with an initial key created by the regional network;
joining, after receiving the node identification from the provisioning server, the regional network, wherein the regional network has no communication with the provisioning server, wherein the module has not joined the regional network prior to the joining;
providing the node identification to the regional network, wherein the regional network uses the node identification and an access code to verify that the module is valid;
receiving, from the regional network, a new encryption key created by the regional network to use when sending data on the regional network;
encrypting data using the new encryption key; and
transmitting the encrypted data on the regional network.

19. The non-transitory computer-readable storage medium of claim 18, wherein the operations further comprise:
receiving a network identification from the regional network prior to joining the regional network; and
determining the module does not have the new encryption key associated with the network identification.

20. The non-transitory computer-readable storage medium of claim 19, wherein the operations further comprise deriving the initial key based upon the network identification.

21. The method of claim 1, wherein the regional network uses the node identification and access code to verify that the module is valid comprises:
providing, by the regional network and to a key storage server, the node identification and the access code;
verifying, by the key storage server, that the access code matches the node identification based on information unavailable to the regional network;
providing, by the key storage server and to the regional network, an indication that the node identification and the access code are a valid pair; and
reprovisioning, by the regional network and in response to receiving the indication, the module for operation on the regional network.
